(19) United States
(12) Patent Application Publication
(10) Pub. No.: US 2002/0067151 A1
(43) Pub. Date: Jun. 6, 2002

(54) Battery charger for portable telephone

(76) Inventor: Isamu Tanishita, Haibara-gun (JP)

Correspondence Address: KANESAKA AND TAKEUCHI, 1423 Powhatan Street, Alexandria, VA, 22314, US

(21) Appl. No.: 09/993,895

(22) Filed: Nov. 27, 2001

(30) Foreign Application Priority Data
Nov. 28, 2000 (JP) 2000-008416

(51) Int. Cl. H02J 7/00

(52) U.S. Cl. 320/114

(57) ABSTRACT

A battery charger for a portable telephone in which the whole of it is simply and lightly formed and with which a battery of the portable telephone can be securely charged is provided.

A battery charger for a portable telephone comprises the main body 1 for storing the box type battery b, the transforming means 2 for transforming the voltage of the box type battery within the main body and the connector 3 for carrying the current of the transformed box type battery which has been connected to the external connection terminal 20 of the portable telephone 19, the main body 1 is equipped with a receiving member 6 for contacting with the electrode side of the box type battery, a joint member 7 for being provided and extended in the longitudinal direction of the box type battery by being connected in line from the receiving member and a supporting member 8 for contacting with the bottom section b1 which is the other side of the electrodes 4, 5 in the box type battery by providing the supporting member 8 on the end section of the joint member and in the main body 1, the at least supporting member is molded by a synthesized resin having a spring character which is freely oscillated with respect to the receiving member side, and the pressurizing member 15 for pressurizing and contacting with the bottom section is projectively provided on the internal face of the supporting member.

### BACKGROUND OF THE INVENTION

1. Field of the Invention

The present invention {contrivance} relates to a battery charger for a portable telephone with which the battery for the relevant portable telephone is capable of being immediately charged when the battery for the portable telephone is dead.

2. Description of the Related Art

Conventionally, for example, an emergence power supply in which a dry battery is stored within case thereof having a connector connected to the external connection terminal of a portable telephone with which the battery is capable of being immediately charged, and the telephone talk can be restarted has been known.

As for these kinds of products, since case thereof for storing the battery was manufactured in such a manner that it wrapped the whole relevant battery, the manufacturing cost became expensive and the exchange of the internal battery was troublesome.

### SUMMARY OF THE INVENTION

The present invention {contrivance} has been made for the purpose of solving the problems described above, and object of the present invention is to provide a battery charger for a portable telephone whose whole body is easily and lightly formed and which is capable of securely charging the portable telephone, the battery charger for a portable telephone comprising: a main body for storing a box type battery, a transforming means for transforming the voltage of the foregoing box type battery, which is provided within this main body, and a connector for carrying the current of the foregoing box type battery transformed as described above by being connected to the external connection terminal of a portable telephone, the foregoing main body having: a receiving member for contacting with the electrode sides of the foregoing box type battery, a joint member for being provided and extended in the longitudinal direction of the foregoing box type battery by being connected in line from the receiving member and a supporting member for contacting with the bottom section which is on the other side of the foregoing electrodes in the foregoing box type battery by providing the supporting member on the end section of this joint member, wherein the foregoing at least supporting member is molded with a synthesized resin having a spring character which is freely oscillated with respect to the foregoing receiving member side, and a pressurizing member for pressurizing and contacting with the foregoing bottom section is projectively provided on the internal surface of the relevant supporting member.

The means for achieving the foregoing object of the present invention {contrivance} is a battery charger for a portable telephone comprising a main body for storing a box type battery, a transforming means for transforming the voltage of the foregoing box type battery provided within this main body, and a connector for carrying the current of the foregoing box type battery, which has been connected to the external connection terminal of the portable telephone and transformed as describe above, the foregoing main body having: a receiving member for contacting with the electrode sides of the foregoing box type battery, a joint member for being provided and extended in the longitudinal direction of the foregoing box type battery by being connected in line from this receiving member and a supporting member for contacting with the bottom section which is on the other side of the foregoing electrodes in the foregoing box type battery by providing the supporting member on the end section of this joint member,

wherein the foregoing at least supporting member is molded by a synthesized resin having a spring character which is freely oscillated with respect to the foregoing receiving member side, and a pressurized member for pressurizing and contacting with the foregoing bottom section is projectively provided on the internal face of the relevant supporting member.

Another means for achieving the foregoing object of the present invention {contrivance} is a battery charger for a portable telephone comprising: a main body for storing a box type battery, a transforming means for transforming the voltage of the foregoing box type battery provided within this main body and a connector for carrying the current of the foregoing box battery, which has been connected to the external connection terminal of the portable telephone and transformed as described above,

the foregoing main body having: a receiving member for contacting with the electrode side of the foregoing box type electrode, a joint member for being provided and extended in the longitudinal direction of the foregoing box type battery by being connected in line from this receiving member and a supporting member for contacting with the bottom section which is on the other side of the foregoing electrode in the foregoing box type battery by providing the supporting member on the end section of this joint member,

wherein the foregoing at least supporting member is molded by a synthesized resin having the spring character which is freely oscillated with respect to the foregoing receiving member side, and a pressurized member for pressurizing and contacting with the foregoing bottom section is projectively provided on the internal face of the relevant supporting member, and

the foregoing joint member is provided and arranged so as to correspond to both side face sections of the foregoing box type battery and the front and rear faces of the relevant box type battery are opened.

Still another means for achieving the foregoing object of the present invention {contrivance} is a battery charger for a portable telephone comprising: a main body for storing a box type battery, a transforming means for transforming the voltage of the foregoing box type battery provided within this main body and a connector for carrying the current of the foregoing box type battery, which has been connected to the external connection terminal of the portable telephone and transformed as described above,

the foregoing main body having: a receiving member for contacting with the electrode side of the foregoing box type battery, a joint member for being provided and extended in the longitudinal direction of the foregoing box type battery by being connected in line from this receiving member and a supporting member for contacting with the bottom section which is on the other side of the foregoing electrode in the foregoing box type battery by providing the supporting member on the end section of this joint member, and

wherein the receiving member in this main body has a pair of terminals for contacting with the electrodes of a convex shaped + pole and concave shaped − pole in the foregoing box type battery, respectively, and a pair of receiving concave sections receiving both electrodes of foregoing box type battery, the pair of receiving concave sections have different concave shapes of the + pole side and the − pole side are differently provided is provided so that the electrodes of the − pole side is not inserted into the receiving concave section of the + pole side.

### BRIEF DESCRIPTION OF THE DRAWINGS

The above object and advantages of the present invention will be apparent by describing the preferred embodiment of the present invention in detail with reference to the attached drawings, in which;

FIG. 1 is a perspective view showing one example of a battery charger for a portable telephone pertaining to the present invention {contrivance};

FIG. 2 is an elevational view showing one portion of the battery charger for a portable telephone in FIG. 1;

FIG. 3 is a side elevation view showing a longitudinal section of the battery charger for a portable telephone in FIG. 1;

FIG. 4 is an illustration showing the corresponding state of a box type battery in the battery charger for a portable telephone in FIG. 1,

FIG. 4(a) shows a terminal section and

FIG. 4(b) shows an electrode section of the box type battery, respectively; and

FIG. 5 is a charging circuit of a battery charger for a portable telephone in FIG. 1.

### DESCRIPTION OF THE PREFERRED EMBODIMENT

Next, one example for carrying out a battery charger for a portable telephone pertaining to the present invention {contrivance} will be described below with reference to the drawings.

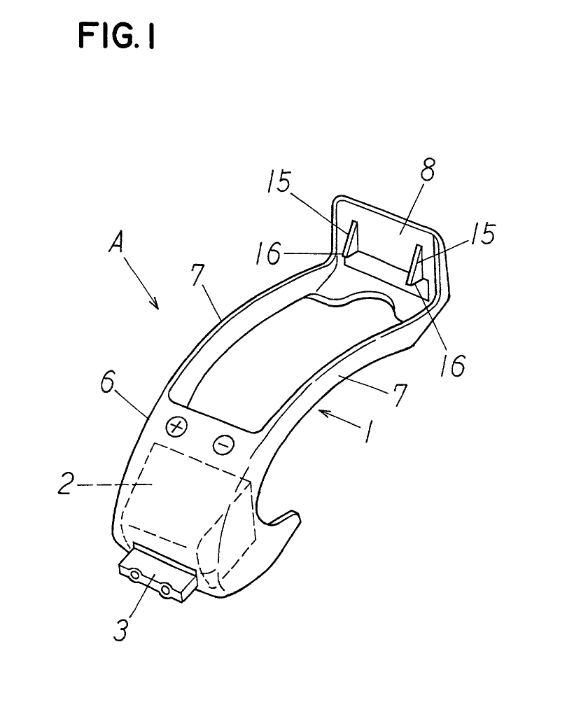

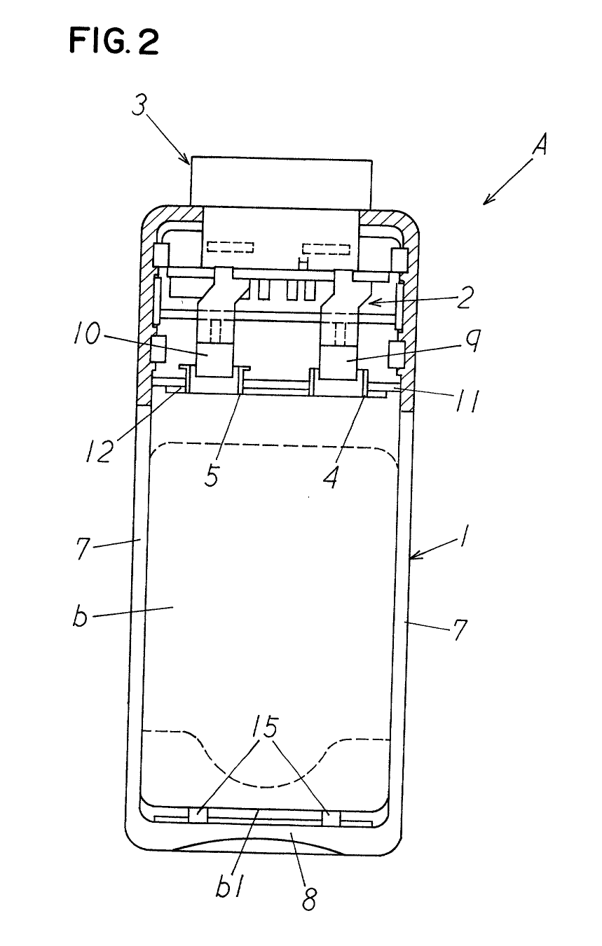

The reference character A in FIG. 1 through FIG. 3 denotes a battery charger for a portable telephone with which the relevant battery of the portable telephone is capable of being immediately charged when the battery of the portable telephone is dead, and is fundamentally configured with a main body 1 and a transforming means 2 and a connector 3.

The main body 1 described above stores a box type battery b, and has a receiving member 6 for contacting with the sides of the electrodes 4 and 5 of the box type battery b, a joint member 7 for being provided and extended in the longitudinal direction of the box type battery b by being connected in line from this receiving member 6 and a supporting member 8 for contacting with the bottom section which is on the other side of the electrodes 4 and 5 in the box type battery b provided on the end section of this joint member 7.

Out of these, the receiving member 6 has a pair of terminals 9 and 10 for contacting with the electrodes of the convex shaped + pole 4 and the concave shaped − pole 5 in the box type battery b, respectively, and a pair of receiving concave sections 11 and 12 for receiving both electrodes 4 and 5 of the box type battery b, and is provided so as to hold and support the sides of the electrodes 4 and 5 of the relevant box type battery b.

Then, this pair of the receiving concave sections 11 and 12 provide the shapes of the concave sections of the + pole 4 side and the − pole 5 side in the box type battery b in different shapes, and the electrodes of the − pole side is provided so as not to be inserted into the + pole side of the receiving convex section.

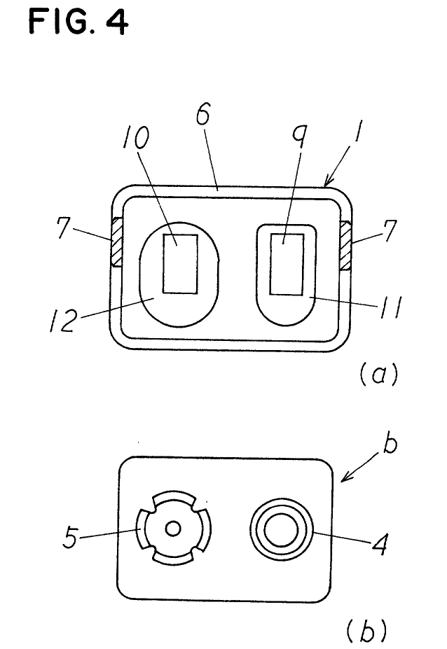

Specifically, as for the shapes of the + pole 4 and the − pole 5 in the box type battery b, as shown in FIG. 4(b), the + pole 4 is in a convex shape, the − pole 5 is in a concave shape and having a larger diameter section whose outer shape section is expanded toward the outer side, and by utilizing the outer diameter difference between this + pole 4 and the − pole 5, as shown in FIG. 4(a), the receiving concave section 11 corresponding to the + pole 4 side is formed in a smaller diameter, into which the − pole 5 cannot be inserted.

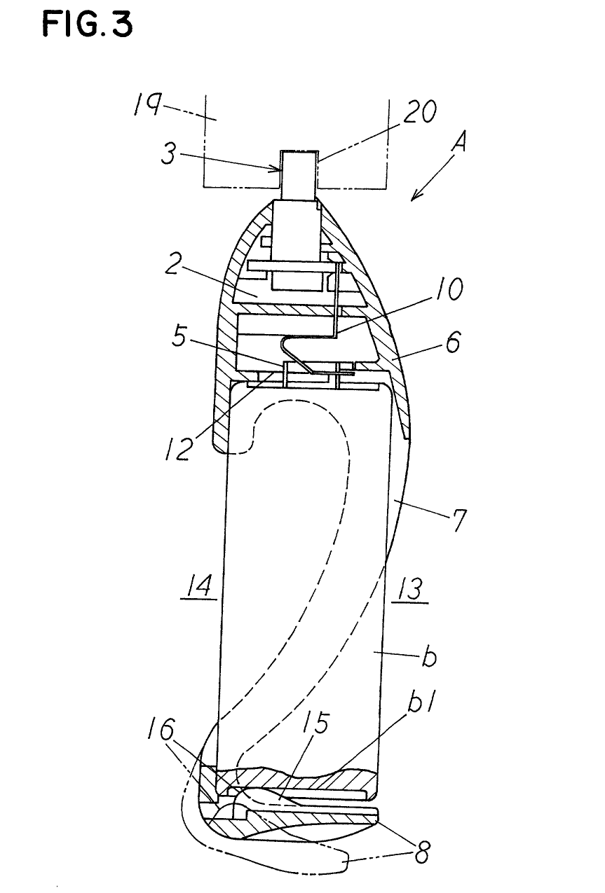

Moreover, the joint member 7 of the main body 1 is provided and arranged so as to correspond to both side face sections of the box type battery b, and as shown in FIG. 3, opening sections 13 and 14 largely opened are provided on the front and rear face of the relevant box type battery b so that the mounting and removal of this box type battery b is easily made.

Furthermore, the supporting member 8 of the main body 1 is molded by a synthesized resin (noted that the whole main body 1 is formed by a synthesized resin) having a spring character which is freely oscillated with respect to the receiving member 6 side, and on the internal face of the relevant supporting member 8, the pressurized member(s) 15 which pressurize and contact with the bottom section b1 of the box type battery b (the other side of the sections of the electrodes 4 and 5) and pressurize the electrodes 4 and 5 to the pair of terminals 9 and 10 are provided and projected at one location or at a plurality of locations.

This pressurizing member 15, as shown in FIG. 3, is formed in a tilt shape so as to be gradually projecting in a predetermined size from the internal face of the supporting member 8 as reaching from the opening section 13 side to the opening section 14 side. Moreover, the relevant box type battery b is made not to be easily released from the main body 1 by the projecting apex section 16 engaging with the concave face section provided on the bottom section b1 of the box type battery b.

Owing to this, as indicated by the imaginary line in FIG. 3, this supporting member 8 is deformed outward and the removal of the box type battery b from the main body 1 is smoothly performed and the box type battery b is securely held in the main body 1 by the spring character of this supporting member 8.

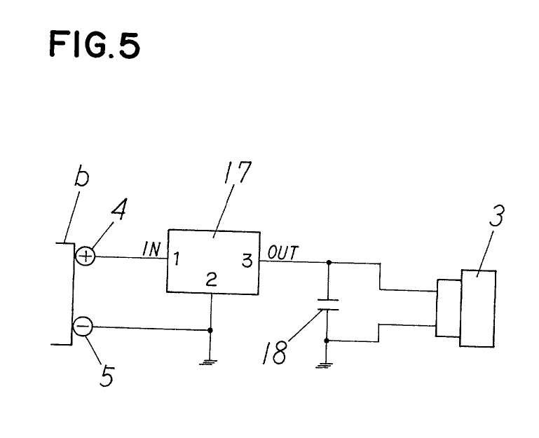

The transforming means 2 described above transforms the voltage of 9V that the box type battery b has into 5V by providing the transforming means 2 within the main body 1, in the circuit of the battery charger shown in FIG. 5, an input voltage from the box type battery b is carried to the connector 3 described later via a condenser 18 for transmission circuit prevention as an output voltage obtained by passing through a three-terminal regulator 17 mounted on the print substrate.

The connector 3 described above carries the transformed current of the box type battery b, which has been connected to the external connection terminal 20 of the portable telephone 19.

Therefore, as to a battery charger for a portable telephone A of the example of the present invention {contrivance} configured as described above, at the time of emergency when the user is out and so forth, in the case where the battery embedded in the portable telephone 19 is exhausted during the usage of the relevant portable telephone 19, if the connector 3 in the battery charger for the portable telephone A is inserted into the external connection terminal 20, the current of the box type battery b mounted on the relevant main body 1 is carried to the external connection terminal 20 via the transforming means 2 and the connector 3.

Owing to this, the battery of the portable telephone 19 rapidly receives the current and can immediately restart the transmitting and receiving.

On the other hand, when the box type battery b mounted on the main body 1 discharges by utilizing it and the predetermined voltage is lowered, if the supporting member 8 of the main body 1, as indicated by the imaginary line in FIG. 3, is made curved outward, it is deflected due to its spring character, the projecting apex section 16 of the pressurizing member 15 which has been engaged with the bottom section b1 of the box type battery b is released from the contacting state, when the box type battery b is made held by hand from the opening section 14, the removal of it is easily performed by hand from the opening section 13.

Moreover, upon mounting the relevant box type battery b on the main body 1, first, if the electrodes 4 and 5 section sides are inserted into the receiving member 6 from the opening section 13 side and the bottom section b1 side is inserted along the pressurizing member 15, the relevant bottom section b1 is easily fitted in by sliding along the slope of the pressurizing member 15, and its projecting apex section 16 gets over the circumferential rim in the bottom section b1 in a concave shape and engages with the face of this bottom section b1.

Owing to this, the box type battery b is held by the predetermined holding pressure between the terminals 9 and 10 and the pressurizing member 15, and the relevant box type battery b is not easily released.

Since in the present invention {contrivance} configured as described above, the main body is simply and lightly formed, it is convenient for carrying at the time of being out and so forth and it can be manufactured at low cost, the box type battery is held by the spring character of the main body, the structure for mounting and holding is simplified and further, the holding ability of the relevant box type battery is largely enhance. Furthermore, since the joint member corresponds to both side sections, the relevant box type battery can be protected.

Moreover, as to the pair of receiving concave sections, the concave shapes of the + pole side and the − pole side are differently provided, and are provided so that the electrode of the − pole side is not inserted to the receiving concave section of the + pole side, therefore, the reverse connection which is caused by erroneously identifying the polarity of the box type battery and erroneously connecting to the different polarity of the box type battery is prevented.

It will also be appreciated that, although a limited number embodiments of the invention have been described in detail for purposes of illustration, various modification may be made without departing from the spirit and scope of the invention. Accordingly, the invention should not be limited except as by the appended claims.

What is claimed is:

1. A battery charger for a portable telephone, said charger comprising:
a main body for storing a box type battery;
transforming means for transforming a voltage of said box type battery within said main body; and
a connector for carrying current of said transformed box type battery, which has been connected to an external connection terminal of a portable telephone,
wherein said main body is equipped with a receiving member for contacting with electrode sides of said box type battery, a joint member for being provided and extended in longitudinal direction of said box type battery by being connected in line from said receiving member and a supporting member for contacting with a bottom section which is the other side of said electrodes in said box type battery provided on an end section of said joint member,
and wherein, said at least supporting member is molded by a synthesized resin having a spring character which is freely oscillated with respect to said receiving member side, and a pressurizing member for pressurizing and contacting with said bottom section is projectively provided on the internal face of said supporting member.

2. A battery charger for a portable telephone, said charger comprising:
a main body for storing a box type battery;
transforming means for transforming a voltage of said box type battery within said main body; and
a connector for carrying current of said transformed box type battery, which has been connected to an external connection terminal of a portable telephone,
wherein said main body is equipped with a receiving member for contacting with electrode sides of said box type battery, a joint member for being provided and extended in longitudinal direction of said box type battery by being connected in line from said receiving member and a supporting member for contacting with a bottom section which is the other side of said electrodes in said box type battery, said supporting member provided on an end section of said joint member,
and wherein said at least supporting member is molded by a synthesized resin having a spring character which is freely oscillated with respect to said receiving member side, a pressurizing member for pressurizing and contacting with said bottom section is projectively provided on the internal face of said supporting member, said joint member is provided and arranged corresponding to both side face sections of said box type battery and front and rear faces of said box type battery are opened.

3. A battery charger for a portable telephone, said charger comprising:
a main body for storing a box type battery;
transforming means for transforming a voltage of said box type battery within said main body; and
a connector for carrying current of said transformed box type battery, which has been connected to an external connection terminal of a portable telephone,
wherein said main body is equipped with a receiving member for contacting with electrode sides of said box type battery, a joint member for being provided and extended in a longitudinal direction of said box type battery by being connected in line from said receiving member and a supporting member for contacting with a bottom section which is the other side or said electrodes in said box type battery, the supporting member provided on an end section of said joint member,
wherein a receiving member in said main body has a pair of terminal for contacting with electrodes of a convex shaped + pole and a concave shaped − pole in said box type battery, respectively, and a pair of receiving concave sections for receiving both electrodes of said box type battery,
and wherein in said pair of receiving concave sections, concave shapes of + pole side and − pole side are differently provided and are provided so that an electrode of − pole side is not inserted into a receiving concave section of + pole side.
